(19) United States
(12) Patent Application Publication
(10) Pub. No.: US 2002/0113379 A1
(43) Pub. Date: Aug. 22, 2002

(54) Sealing device

(76) Inventor: Horst Giebel, Manching (DE)

Correspondence Address: WILLIAM COLLARD, COLLARD & ROE, P.C., 1077 NORTHERN BOULEVARD, ROSLYN, NY, 11576, US

(21) Appl. No.: 10/079,190

(22) Filed: Feb. 19, 2002

(30) Foreign Application Priority Data
Feb. 20, 2001 (DE) 201 03 010.1

(51) Int. Cl. F16J 15/48

(52) U.S. Cl. 277/646

(57) ABSTRACT

A sealing device seals the inner side of pipelines and building openings. The sealing device comprises a rim, which is closed on the inner side by a panel. A tube with a ring-shaped wall made of elastomeric material is mounted on the rim. The tube encloses a sealed hollow space that can be filled with compressed gas. So that the tube will substantially expand only in the radial direction when it is filled with compressed gas, the wall of the tube comprises a reinforcement with increased tensile strength exclusively in the radial area. Furthermore, so that a number of sealing devices can be assembled one directly next to the other, the sealing device comprises a counterpressure panel. The tube is pressed against the rim and against the counterpressure panel.

### BACKGROUND OF THE INVENTION

1. Field of the Invention

The invention relates to a sealing device comprising a tube with a ring-shaped wall made of elastomeric material and enclosing closed hollow space fillable with a gas. The tube has at least one reinforcement made of a material with higher tensile strength than the wall of the tube.

2. The Prior Art

A sealing insert consisting of a solid plate for sealing openings of buildings is known from German Patent No. DE 44 37 909 A1. A rim holding a ring-shaped tube made of elastomer material is retained on the plate. The tube can be filled with compressed air, so that it is radially expanded outwards and pressed against the inner side of the opening of the building. The opening of the building can be sealed watertight in this way in order to prevent any flooding of the interior space of the building in the event of high water. However, the rim has to be very precisely adapted to the opening of the building so that the elastomer tube is adequately safely guided. If the rim is dimensioned too short, this poses the risk that the tube becomes folded around the free end of the rim as it is being inflated, so that no adequate force of contact with the wall of the opening of the building is achieved. Furthermore, this poses the risk that the tube may be destroyed by the free end of the rim.

### SUMMARY OF THE INVENTION

It is therefore an object of the invention to provide a sealing device that permits the sealing of bodies with different inside dimensions.

This and other objects are accomplished by a tube having a ring-shaped wall made of elastomeric material and enclosing a closed hollow space fillable with a gas. The tube has at least one reinforcement in the area extending radially in relation to the ring plane, that is made of a material having higher tensile strength than the wall of the tube.

For compensating the inside dimensions of the body to be sealed, in particular a pipeline or opening of a building, the sealing device as defined by the invention comprises an elastomer tube with a ring-shaped wall. It has been found in practical life that a compensation of the diameter or of the width in the order of magnitude of about 10 cm is required in order to be able to safely seal differently shaped openings of buildings or pipelines covered with deposits. In order to prevent the tube from turning inside out over any rim that may be installed, the wall of the tube is made with a greater elasticity in the area of its surface directed at or facing the inner or outer side of the ring than in a zone extending substantially radially in relation to the plane of the ring. This is achieved such that in the radial area, the tube has a reinforcement consisting of a material resistant to tensile stress. The reinforcement provides for stabilization of the form of the tube in the reinforced area. The reinforced areas of the tube assure that the tube will preferably expand in the more elastic areas radially in relation to the plane of the ring as it is being filled with compressed air. Viewed in the cross section, this means that the tube assumes an elliptic or oval shape as the inside pressure rises without having the tendency to turn inside out sideways. This means that a rim on which the tube is mounted can be shortened accordingly without posing the risk that the tube may turn inside out over the free end of the rim. Thus the tube will achieve in a very simple manner the desired compensation of the length or diameter in order to be able to correctly seal differently dimensioned pipelines or openings of buildings.

So that the sealing device can be adapted as optimally as possible to the inner surface of the pipeline or opening of the building, the tube is designed so that it has a substantially rectangular cross section in the deflated condition. If need be, there can be a rounding in the area of transition between the radial area and the axial area. Alternatively, it is advantageous to provide an elliptic or oval cross section of the tube in order to achieve good adaptation to a partially torus-shaped rim. The longitudinal side of the cross section of the tube wall is directed at the inner side of the ring, so that a particularly large area of adaptation of the sealing device to different inside dimensions of the pipeline or opening of the building is obtained. As the tube is being filled with compressed gas, its cross section assumes an increasingly oval shape without the risk that it will turn inside out sideways over any rim that may be present.

For achieving the elasticity desired in the area of the annular inner or outer side of the tube these areas are designed with a lower wall thickness or lower Shore hardness. A lower wall thickness can be realized simply by designing the molding dies accordingly. Alternatively, it is conceivable also to vulcanize an additional layer of elastomeric material to the tube in the radial area. Such an additional layer could have a higher Shore hardness in order to further increase the difference in the elasticity of the tube between the radial area and the area on the inside or outside.

The reinforcement is advantageously formed by glass, carbon or textile fibers, which can be bent very easily and thus adapted to the shape of the tube, whereby such fibers have nonetheless very high tensile strength. Such fibers provide the tube with a particularly good dimensional stability versus elongation, whereby an adequate flexibility of the tube remains maintained in the reinforced area as well.

In order to obtain the best possible dimensional stability in the area of the reinforcement when the tube is filled with compressed gas, it is favorable if the fibers extend substantially radially in relation to the plane of the ring. The tensile force of the elastomeric material acts the strongest in this direction, so that the fibers achieve the best possible stabilization. As an alternative, the fibers can have the structure of a matting that exhibits adequate tensile stability in all directions.

To achieve the closest possible intimate joint between the tube and the pipeline or opening of the building, the outer annular side of the wall of the tube is provided with at least one sealing strip. The sealing strip has a lower Shore hardness than the wall of the tube, so that the sealing strip is capable of adapting itself well to a rough surface. This is important especially in connection with openings of brickwork buildings, or with pipelines having deposits or sedimentation adhering to them.

So that the tube can be filled with compressed gas, it is fitted with a valve. The valve can be located at any desired point of the tube as long as its location does not impair the sealing effect of the tube versus the pipe or building opening. However, it is advantageous if the valve is placed in the area of the tube extending radially in relation to the plane of the ring. This permits the tube to rest fully flatly on the rim over its entire length. Furthermore, in this case, the valve is located in a stiffer area of the tube and, moreover, it is accessible in a very easy way.

If the size of the building opening or pipeline is so large that it cannot be completely closed by one single sealing device, it is basically necessary provide a number of sealing devices arranged next to one another, or one on top of the other. This, however, is disadvantageous because two elastomeric tubes have to be pressed against each other in that case. This leads to mutual axial displacement of the sealing devices in spite of any reinforcement that may be present in the radial area, and would considerably impair the sealing effect of the entire arrangement. For eliminating this problem, a counter pressure plate is mounted on a rim or on a panel closing the rim, and extending over the outer side of the tube. In this area, the tube thus applies pressure to the rim, and to the counter-pressure plate, so that no leakage or tightness problem will arise. In such a case, an additional sealing device can be attached to the counterpressure plate that will prevent two tubes from directly resting against one another.

To safely seal the building opening or pipeline in the area of the face sides of the counterpressure plate, there is at least one sealing body on the face side of the counterpressure plate. Preferably, there is a sealing body on each of the two faces opposing each other and facing the building opening or the pipeline in order to assure sealing on all sides.

In order to assure that a good sealing effect of the additional sealing body is obtained, the sealing body is produced from elastomeric material. The Shore hardness of the sealing body has to be as low as possible so as to assure adaptation of the body to the building opening or pipeline lengthwise. If the sealing body has a length of about 2.5 cm, it has a Shore hardness of no more than 10. If the sealing body has a greater length than that, the Shore hardness can be raised accordingly without losing the desired adaptability lengthwise. The sealing body is arranged in this connection so that it can be compressed by the tube. This offers the advantage that the sealing body is pressed more forcefully against the building opening or pipeline when the tube is inflated.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows the frame of a door with installed sealing devices according to the invention;

FIG. 2 is a three-dimensional representation of a tube for sealing a pipeline;

FIG. 3 is a sectional representation showing a section through the tube in the deflated state;

FIG. 4 shows the tube according to FIG. 3 under pressure (or inflated);

FIG. 5 is a sectional representation with a section through an alternative embodiment of a tube; and

FIG. 6 is a sectional representation showing a section through an alternative embodiment of a tube.

### DETAILED DESCRIPTION OF THE PREFERRED EMBODIMENTS

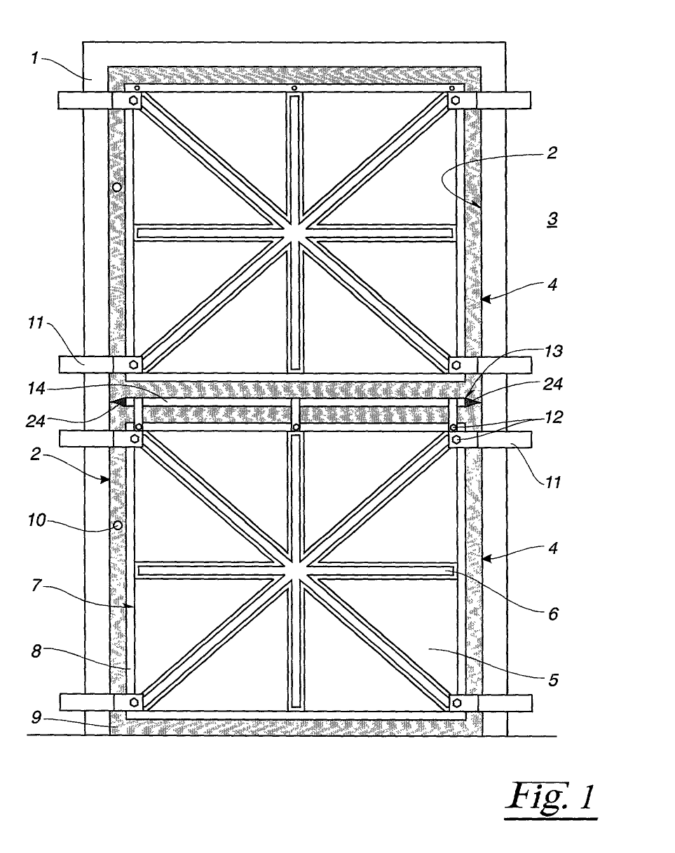

Referring now in detail to the drawings, FIG. 1 shows a doorframe 1 enclosing an opening 2 of a building 3. In order to protect building 3 against flooding in the event of an acute threat of high water, the two sealing devices 4 are installed in building opening 2. Sealing devices 4 tightly seal building opening 2. Sealing devices 4 substantially have the same structure and are explained in greater detail in the following.

Sealing device 4 consists of a panel 5 that is stiffened by a number of struts 6. Struts 6 may consist of separate bars connected with panel 5. As an alternative, struts 6 can be designed in the form of stiffening corrugations, so that the corrugations and panel 5 are produced in the form of one single piece. In case panel 5 consists of a cast structural component, struts 6 can be molded onto panel 5 in order to assure the advantage offered by a single-piece type of construction. Struts 6 provide panel 5 with the required bending stiffness, so that panel 5 is capable of withstanding the pressure of the water, with panel 5, however, being nonetheless relatively thin, and it can be produced as a type of lightweight construction element. This is important because sealing device 4 has to be inserted in the individual building openings 2 by hand, as a rule.

A rim 8 extending all around and serving the purpose of receiving tube 9 is supported on outer periphery 7 of panel 5. Tube 9 is made of an elastomeric material and its interior can be filled with a gas, in particular compressed air. So that tube 9 can be adequately adapted to differently dimensioned building openings 2, it projects beyond rim 8 by at least half of its cross section. If the clear width of building opening 2 is slightly smaller, rim 8 can be nonetheless installed in said opening without problems. A correspondingly lesser amount of gas in the tube will suffice in order to achieve correct sealing.

Tube 9 can be filled via a valve 10 axially aligned with the tube. By filling the tube with compressed gas, in particular compressed air, it is firmly pressed against the inner walls of the building opening 2, so that tube 9 is tightly resting against building opening 2.

So as to prevent the entire sealing device 4 from being pushed into building opening 2 by the pressure of the water, angles 11 are secured on panel 5 and/or on rim 8. Angles 11 extend over doorframe 1 on the outer side. For facilitating the installation and for supporting sealing device 4, angles 11 are fixed on panel 5 via detachable fastening means 12, in particular screws.

In FIG. 1, one sealing device 4 will not suffice for tightly sealing the entire building opening 2. However, if the level of the high water to be expected rises up to the top edge 13 of sealing device 4 at the most, an adequately safe sealing of the building opening 2 is assured nonetheless. However, if the high water rises to an extremely high level, only one sealing device 4 may no longer suffice for protecting building 3. It is necessary in that case to seal the building opening 2 with a number of sealing devices, in the present exemplified embodiment with two of sealing devices 4.

In order to prevent the two tubes 9 of sealing devices 4 from pushing each other away, which would lead to an untight or leaky connection between tubes 9, a counterpressure panel 14 is supported on the top side of lower sealing device 4. Counterpressure panel 14 extends over tube 9 on the top side, so that the top area of lower tube 9 and the bottom area of upper tube 9 are pressed against rim 8, and against counterpressure panel 14. In this way, the two tubes 9 apply pressure exclusively in the radial direction, so that no shear forces impairing the connection will occur. So that the same sealing device 4 can be installed in building opening 2 as the lower termination and as the upper termination, counterpressure panel 14 is mounted on rim 8 or panel 5 via additional detachable fastening means. In this way, counterpressure panel 14 can be very easily separated from sealing device 4 in order to be installed as the upper termination of building opening 2.

In order to make sure that adequately safe sealing of building opening 2 is achieved in the area of counterpressure panel 14 as well, counterpressure panel 14 is provided with a sealing body 24 on each of its face sides. Such a sealing body 24 is made of an elastomeric material with a Shore hardness of less than 10, so that the two sealing bodies 24 will rest against building opening 2 in a sealing manner. Counterpressure panel 14 is designed so that tubes 9 of sealing devices 4, when in the inflated state, will be pressed against sealing bodies 24, compressing the latter. In this way, sealing bodies 24 are even more forcefully pressed against the building opening 2 in order to assure adequately safe sealing of building opening 2 within the zone of counterpressure panel 14 as well.

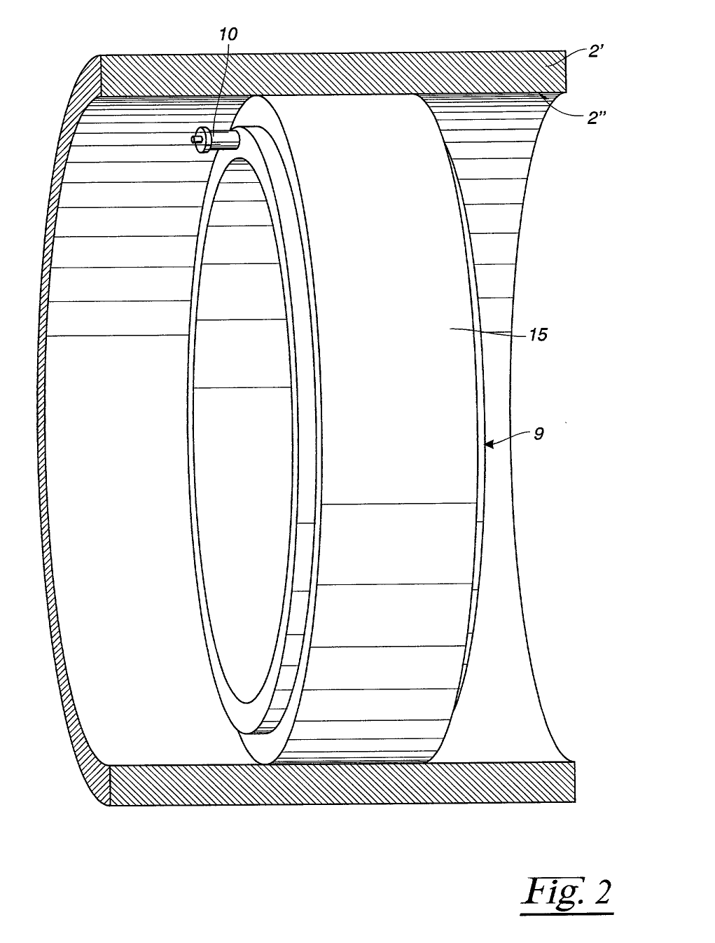

FIG. 2 shows a three-dimensional representation of tube 9 of sealing device 4, with the latter being removed from rim 8. Tube 9 has a substantially hollow-cylindrical outer contour and comprises a hollow space (not visible) for receiving the compressed air. When circular rims are used, tube 9 can be employed also for sealing pipelines. This is particularly important for checking the tightness of a pipeline 2′ or a pipeline junction. In the present case, it is not necessary to seal the rim of the sealing device by a panel or plate. It rather suffices to mount two sealing devices 4 on the two ends of a pipe segment, so that a test space is obtained between tubes 9, the pipe segment and pipeline 2′ to be tested, and the tightness of such a test space can be easily checked. In this way, it is possible especially in connection with sewer pipes to check the sewer pipes for tightness without obstructing the flow of sewage through the sewer.

In order to achieve tight abutment of tube 9 to the building opening 2 or inner wall 2″ of a pipeline, a sealing strip 15 is provided on the outer periphery of tube 9. Sealing strip 15 has a substantially lower Shore hardness than tube 9. Sealing strip 15 is preferably vulcanized to the outer wall of the tube in order to achieve a tight bond between sealing strip 15 and tube 9. As opposed to tube 9, sealing strip 15 can be deformed in a particularly easy way, so that it is fitted as snugly as possible to uneven spots of building opening 2 or the inner side of the pipelines.

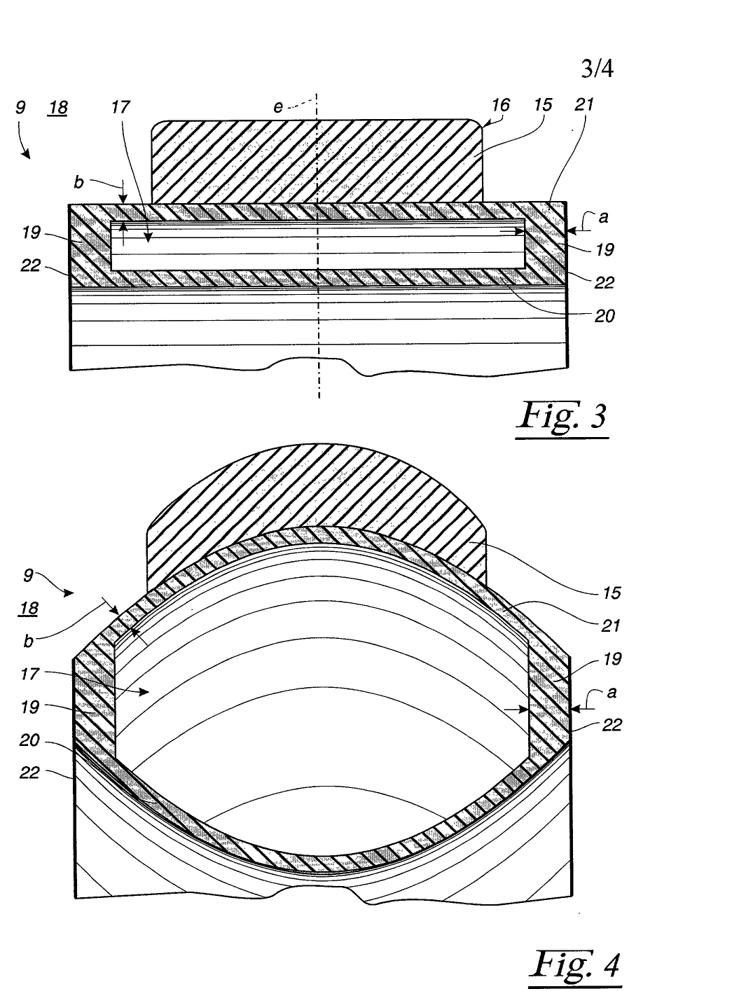

FIG. 3 shows a section through tube 9 according to FIG. 2, whereby sealing strip 15 has rounded edges 16. The shape of the edges of sealing strip 15 has no influence at all on the proper function of sealing device 4. Tube 9 has a substantially rectangular cross section with a rectangular hollow space 17, which can be filled with compressed gas, in particular with compressed air.

In the deflated state shown in FIG. 3, the pressure in hollow space 17 is the same as in outer space 18, so that no elastic deformations are present in tube 9. In its areas 19 extending radially in relation to the plane e of the ring, tube 9 has a greater wall thickness “a” than in inner area 20 and outer area 21. Inner area 20 and outer area 21 extend axially in relation to the ring plane e, whereby tube 9 has a wall thickness “b” in order to permit elastic deformation. In addition, in area 19 extending radially in relation to the ring plane e, tube 9 comprises on its outer side a reinforcement 22 that is preferably formed by a material having tensile strength. In particular, reinforcement 22 is formed by a textile fiber matting. Reinforcement 22 provides area 19 of tube 9 with increased dimensional stability.

FIG. 4 shows tube 9 according to FIG. 3, whereby hollow space 17 is filled with compressed air. Because of the pressure difference prevailing between inner space 17 and outer space 18, tube 9 has expanded as compared to the tube shown in FIG. 3. Such expansion substantially takes place in inner area 20 and outer area 21 of tube 9, so that tube 9 as a whole assumes an about oval shape. The greater wall thickness “a” and reinforcement 22 in the radial area of tube 9 lead to a stabilization of tube 9 in said area, so that inner area 20 and outer area 21 are exclusively bulging outwards in a convex form. This prevents tube 9 from turning inside out in the axial direction like a bead, which could lead to damage of tube 9 on rim 8.

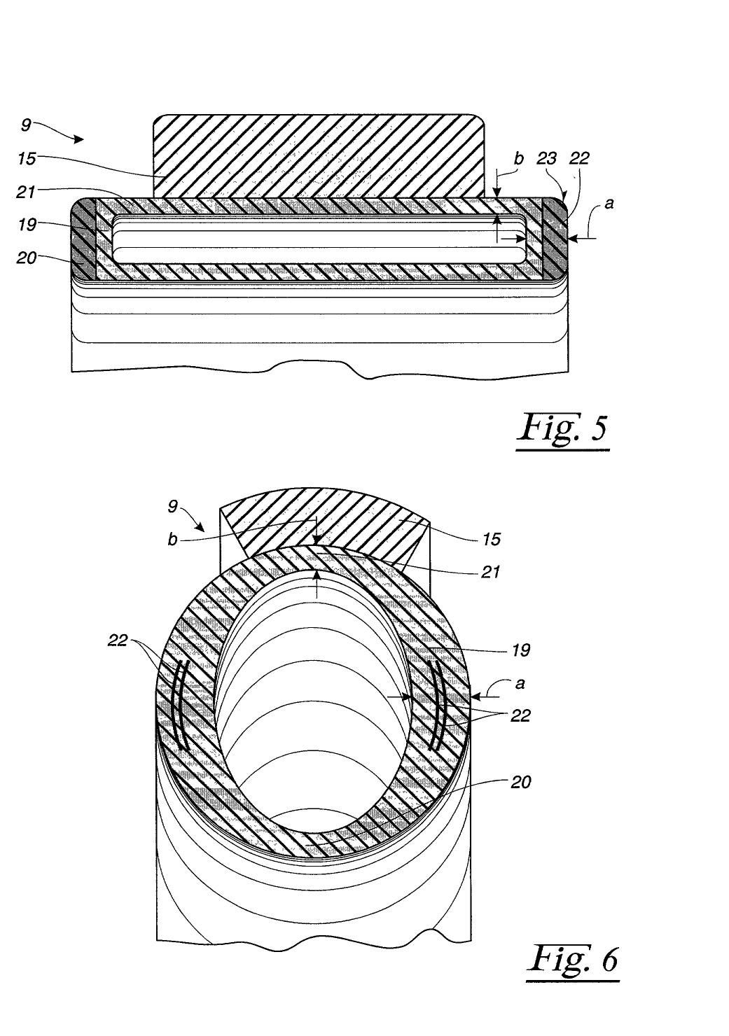

FIG. 5 shows a section through an alternative embodiment of tube 9 according to FIG. 3. A reinforcement 22 is vulcanized to tube 9 in radial area 19. Reinforcement 22 consists of an elastomeric material with a higher Shore hardness than the remaining tube 9. This means that the part of tube 9 without the reinforcement can be produced with an approximately constant wall thickness “a”, which simplifies the manufacture of tube 9. However, it is basically conceivable also to produce tube 9 in its reinforcement-free radial area 19 with a greater wall thickness than in outer wall area 21.

As compared to the embodiment shown in FIG. 3, the greater Shore hardness of reinforcement 22 results in an even better dimensional stability of tube 9 in radial area 19, so that wall thickness “a” could be reduced accordingly in said area, if need be. Deviating from the embodiment according to FIG. 3, the tube is rounded in its edge zone 23, so when the tube is expanding, this will lead to superior distribution of the elastic deformations resulting from such expansion.

Finally, FIG. 6 shows another alternative embodiment of a tube 9, which, as opposed to the embodiments described above, has a substantially elliptic shape. It would be conceivable also to provide tube 9 with a circular cross section or an oval shape without substantially altering the function of the tube. The elliptic shape of tube 9 results in a particularly favorable adaptation of tube 9 to partially torus-shaped rims. As opposed to the embodiments described above, the wall thickness “a” in the radial area continually merges into the lower wall thickness “b” of the inner area 20 and the outer area 21. This effects a favorable distribution of the forces within tube 9 when deforming forces are acting on the latter.

Furthermore, reinforcements 22 are embedded in radial area 19. Such reinforcements may be formed by fibers having tensile strength. An additional stabilization of the radial areas 19 is obtained in this way. As an alternative to the embodiment according to FIG. 6, reinforcement 22 could be attached to the surface of the tube as well.

Accordingly, while only a few embodiments of the present invention have been shown and described, it is obvious that many changes and modifications may be made thereunto without departing from the spirit and scope of the invention.

What is claimed is:

1. A sealing device comprising:
a tube with a wall forming a ring and made of elastomeric material and enclosing a closed hollow space fillable with a gas; and
at least one reinforcement made of a material having higher tensile strength than the wall of the tube, said reinforcement being disposed exclusively in an area extending substantially radially in relation to a plane of the ring.

2. The sealing device according to claim 1, wherein said device seals an inner side of a pipeline.

3. The sealing device according to claim 1, wherein said sealing device seals an inner side of a building opening.

4. The sealing device according to claim 1, wherein in a deflated state, the wall of the tube has a substantially rectangular cross section with a substantially rectangular opening forming the hollow space, wherein the wall of the tube is directed at an inner side of the ring with a longitudinal side of its cross section, and having narrow sides extending substantially radially in relation to the plane of the ring.

5. The sealing device according to claim 1, wherein in a deflated state, the wall of the tube has a substantially elliptic cross section with a substantially elliptic opening forming the hollow space, wherein the wall of the tube is directed with a longitudinal side of its cross section at an inner side of the ring and having narrow sides extending substantially radially in relation to the plane of the ring.

6. The sealing device according to claim 1, wherein in the deflated state, the wall of the tube has a substantially oval cross section with a substantially oval opening forming the hollow space, wherein the wall of the tube is directed at an inner side of the ring with a longitudinal side and having narrow sides extending substantially radially in relation to the plane of the ring.

7. The sealing device according to claim 1, wherein surfaces of the wall directed at an inner side and an outer side of the ring have a lower wall thickness (b) or lower Shore hardness than in an area extending substantially radially in relation to the plane of the ring.

8. The sealing device according to claim 1, wherein the reinforcement comprises at least one fiber selected from the group consisting of glass, carbon and textile fibers.

9. The sealing device according to claim 8, wherein the fibers extend substantially radially in relation to the plane of the ring.

10. The sealing device according to claim 8, wherein the fibers are shaped into a matting.

11. The sealing device according to claim 1, wherein at least one sealing strip made of elastomeric material is attached to an outer side of the ring, said sealing strip having a lower Shore hardness than the wall of the tube.

12. The sealing device according to claim 1, wherein the tube comprises at least one valve in an area extending substantially radially in relation to the plane of the ring.

13. The sealing device according to claim 1, wherein the tube is mounted with its annular inner side on a rim that is closed on an inner side by a panel, and wherein a counterpressure plate is supported on the rim, said counterpressure plate extending over the tube in a partial area of its outer circumference, wherein the tube is pressed against the rim on the inner side, and against the counterpressure plate on an outer side.

14. The sealing device according to claim 1, wherein an inner annular side of the tube is mounted on a rim, said rim being closed on its inner side by a panel, wherein a counterpressure panel is supported on the rim, said counterpressure panel extending over the tube in a partial area of its outer circumference, wherein the tube is pressed against the rim on the inner side and against the counterpressure panel on an outer side.

15. The sealing device according to claim 13, further comprising at least one sealing body located on a face side of the counterpressure panel.

16. The sealing device according to claim 14, further comprising at least one sealing body located on a face side of the counterpressure panel.

17. The sealing device according to claim 15, wherein the sealing body is made of elastomeric material and is compressible by the tube.

18. The sealing device according to claim 16, wherein the sealing body is made of elastomeric material and is compressible by the tube.
